(19) United States
(12) Patent Application Publication
(10) Pub. No.: US 2024/0249872 A1
(43) Pub. Date: Jul. 25, 2024

(54) INTEGRATED MAGENTIC ASSEMBLY INCLUDING A MULTI TURN INDUCTOR ON A MULTI-COMPONENT CORE

(71) Applicant: ACLeap Power Inc., Taipei City (TW)

(72) Inventor: Robert James Catalano, Mesquite, TX (US)

(21) Appl. No.: 18/159,436

(22) Filed: Jan. 25, 2023

(51) Int. Cl. H01F 27/26; H01F 27/30; H01F 41/02; H01F 41/04

(52) U.S. Cl. CPC H01F 27/26; H01F 27/306; H01F 41/0206; H01F 41/04

(57) ABSTRACT

An integrated magnetic assembly includes a first core component, a second core component, and a center core component. The center core component is located between and is coupled to the first and second core components. A winding including a pair of winding plates, a pair of winding legs extending from a first end of the pair of winding plates, a pair of connection legs extending from a second end of the pair of winding plates, and a connection tab joining the connection legs. The first core component and the center core component are coupled, defining at least two first channels, and the second core component and the center core component are coupled, defining at least two second channels. Each of the winding legs and each of the connection legs are located in one of the two first channels or one of the two second channels.

### BACKGROUND

The field of the disclosure relates to integrated magnetic assemblies which may be incorporated into electronic circuits of a wide variety of devices. There is a desire to maximize the power provided while minimizing the size of the integrated magnetic assembly. In other words, a higher power density is desired.

As frequencies increase, the losses in the magnetic core become more significant, limiting the types of materials used to those with lower flux densities. On the other hand, lower frequencies require higher inductance values, resulting in physically large inductors. Therefore, historically, needs are met by using single turn windings on large magnetic cores.

A solution is needed which can provide the appropriate power while occupying a sufficiently small footprint. One approach consists of using multiple inductors connected in series and distributed throughout a power module. However, this approach leads to risk associated with multiple solder joints, thereby affecting reliability. Further, physical space is not optimized because additional space is required for additional leads and space between the serially connected inductors.

Based on the forgoing discussion, it therefore remains desirable to improve upon integrated magnetic assemblies so that a higher power density may be achieved.

### BRIEF DESCRIPTION

In one aspect, an integrated magnetic assembly is provided. The magnetic assembly includes a first core component including a first plurality of legs extending from a first inner face, a second core component including a second plurality of legs extending from a second inner face, and a center core component. The center core component is located between the first core component and the second core component and is coupled to the first and second core components. The center core component includes a top surface, a first inner side, and a second inner side. The magnetic assembly further includes a winding including a pair of winding plates, a pair of winding legs extending from a first end of the pair of winding plates, a pair of connection legs extending from a second end of the pair of winding plates, and a connection tab joining the connection legs. The first plurality of legs of the first core component and the first inner side of the center component are coupled, defining at least two first channels, and the second plurality of legs of the second core component and the second inner side of the center component are coupled, defining at least two second channels. Each of the winding legs and each of the connection legs are located in one of the two first channels or one of the two second channels.

In another aspect, a method for assembling an integrated magnetic assembly is provided. The method includes coupling a winding with a center core component of a magnetic core assembly. The winding includes a pair of winding plates, a pair of winding legs extending from a first end of the pair of winding plates, a pair of connection legs extending from a second end of the pair of winding plates, and a connection tab joining the connection legs. The center core component includes a top surface, a first inner side, and a second inner side. Each of the winding legs and each of the connection legs are coupled with the center core component. The method further includes coupling a first core component to the center core component, defining at least two first channels. The method further includes coupling a second core component to the center core component, defining at least two second channels. Each of the winding legs and each of the connection legs are located in one of the two first channels or one of the second two channels.

In another aspect, an integrated magnetic assembly is provided. A magnetic core assembly includes a first core component, a second core component and a center core component. The center core component is located between the first core component and the second core component and is coupled to the first core component and the second core component. The center core component includes a top face, a first side and a second side. The integrated magnetic assembly further includes a winding including a pair of winding plate, a pair of winding legs extending from a first end of the pair of winding plates, a pair of connection legs extending from a second end of the pair of winding plates, and a connection tab joining the connection legs. At least two first channels are defined between the first core component and the center core component, and at least two second channels are defined between the second core component and the center core component. Each of the winding legs and each of the connection legs are located in one of the two first channels or one of the two second channels.

### DRAWINGS

These and other features, aspects, and advantages of the present disclosure will become better understood when the following detailed description is read with reference to the accompanying drawings in which like characters represent like parts throughout the drawings, wherein:

FIG. 1 depicts an exploded view of an embodiment of an integrated magnetic assembly including four toroids connected in series.

FIG. 2 depicts an assembled view of the embodiment in FIG. 1.

FIGS. 3A-3D depict additional assembled views of the embodiment in FIG. 1.

FIG. 4 is a conceptual drawing showing the current and flux flow of the embodiment shown in FIG. 2.

FIG. 5 depicts an exploded view of another embodiment of an integrated magnetic assembly.

FIG. 6 depicts a method of assembling the integrated magnetic assembly depicted in FIG. 5.

FIG. 7 depicts an assembled view of the embodiment depicted in FIG. 5.

FIGS. 8A-8C depict additional assembled views of the embodiment depicted in FIG. 7.

FIG. 9 is a conceptual drawing showing the current and flux flow of the embodiment depicted in FIG. 7.

FIG. 10 depicts an exploded view of another embodiment of an integrated magnetic assembly.

FIG. 11 depicts a method of assembling the integrated magnetic assembly depicted in FIG. 10.

FIG. 12 depicts an assembled view of the embodiment depicted n FIG. 10.

FIGS. 13A-13D depict additional views of the embodiment depicted in FIG. 12.

FIG. 14 is a conceptual drawing showing the current and flux flow of the embodiment depicted in FIG. 12.

Unless otherwise indicated, the drawings provided herein are meant to illustrate features of embodiments of this disclosure. These features are believed to be applicable in a wide variety of systems comprising one or more embodiments of this disclosure. As such, the drawings are not meant to include all conventional features known by those of ordinary skill in the art to be required for the practice of the embodiments disclosed herein.

### DETAILED DESCRIPTION

In the following specification and the claims, reference will be made to a number of terms, which shall be defined to have the following meanings.

The singular forms “a”, “an”, and “the” include plural references unless the context clearly dictates otherwise.

“Optional” or “optionally” means that the subsequently described event or circumstance may or may not occur, and that the description includes instances where the event occurs and instances where it does not.

Approximating language, as used herein throughout the specification and claims, may be applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value. Here and throughout the specification and claims, range limitations may be combined and/or interchanged, such ranges are identified and include all the sub-ranges contained therein unless context or language indicates otherwise.

In an effort to reduce the size and maximize the power, an integrated magnetic assembly is described herein. The integrated magnetic assembly combines multiple inductors into a single structure, saving time and decreasing cost. Further, reliability is increased due to the decreased number of solder joints, reducing the likelihood of failure.

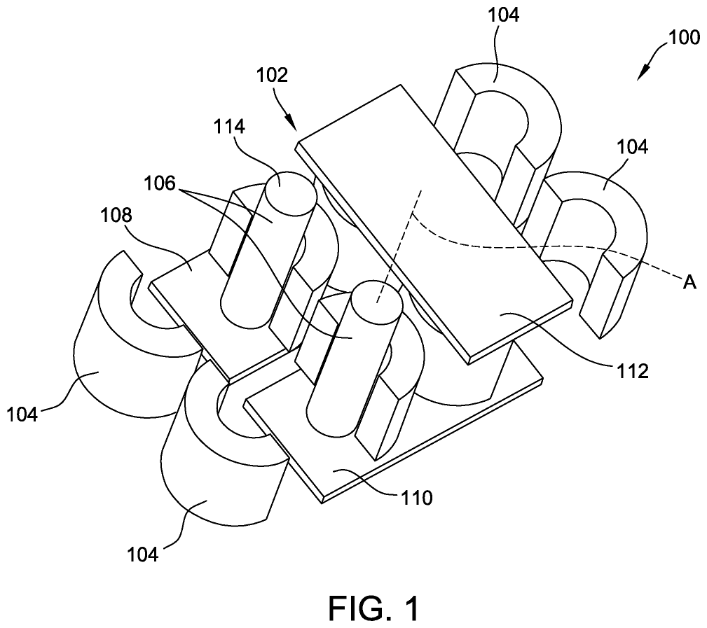

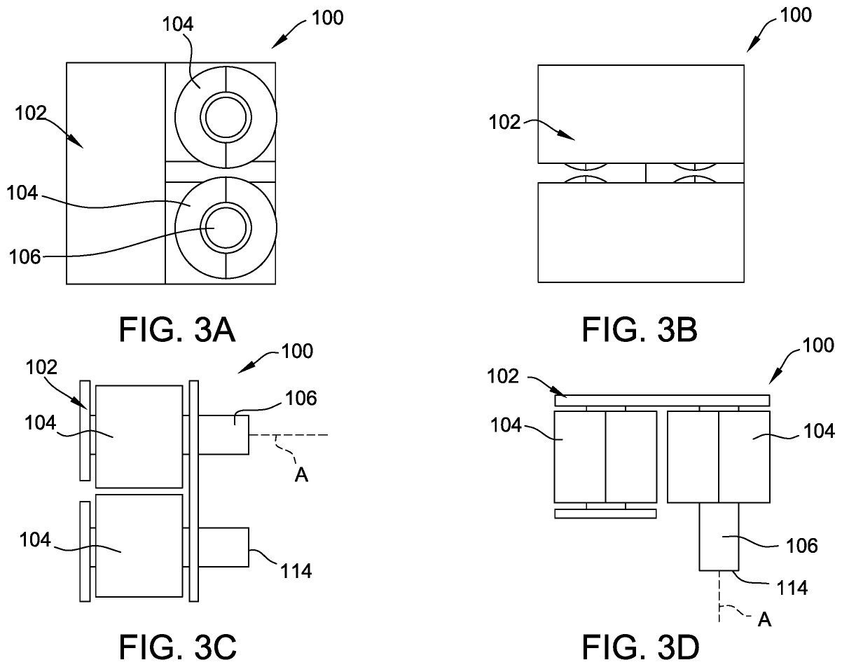

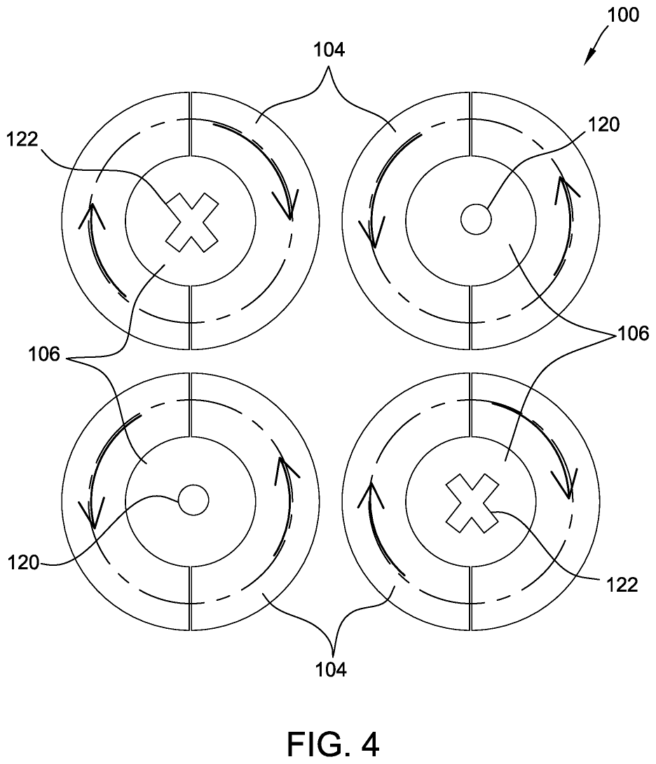

FIGS. 1-3 depict an embodiment of an integrated magnetic assembly 100 including a winding 102 and a plurality of toroids 104 connected in series. The winding 102 forms a continuous conductor, such that the toroids 104 are connected in series. The shape of the winding 102 allows for a more compact overall size of the integrated magnetic assembly 100. The winding 102 may be copper or any desired conductive material. The winding 102 includes a plurality of winding legs 106. Two winding legs are visible in FIGS. 1-3, however, in this embodiment, four winding legs are present. The winding legs 106 are depicted as cylindrical, however, any suitable shape (rectangular, square, round, etc.). An axis A is defined along a longitudinal axis of each of the winding legs 106.

The winding 102 further includes a first winding base plate 108 and a second winding base plate 110. One winding legs 106 extend from each of the first and second winding base plates 108, 110. Two additional winding legs (not shown) extend from the opposite end of the first and second winding base plates 108, 110. The winding base plates are depicted as rectangular but may be any suitable shape. In the present embodiment, the winding legs 106 extend outward from the winding base plates 108, 110 at both ends of the winding base plates 108, 110. However, in other embodiments, the winding legs 106 may be located in any location on the winding base plates 108, 110. Winding 102 further includes a winding connection plate 112. The winding connection plate 112 connects to a first end 114 of two of the winding legs 106. The winding connection plate 112 may be substantially similar to the winding base plates 108, 110, or may be any different, suitable shape. The winding legs 106, the winding base plates 108, 110 and the winding connection plate 112 form an electrically continuous winding.

The integrated magnetic assembly further includes a plurality of toroids 104. In the exploded view of FIG. 1, each toroid 104 is shown as a gapped toroid, fabricated as two halves which are joined together. However, in other embodiments, the toroids may also be fabricated as one piece. The toroids 104, comprising a single unitary member or two or more sections, are located along and adjacent to the winding legs 106, such that each toroid 104 is wound around one of the winding legs 106. The toroids 104 are cylindrical in the present embodiment, but any suitable shape may be used.

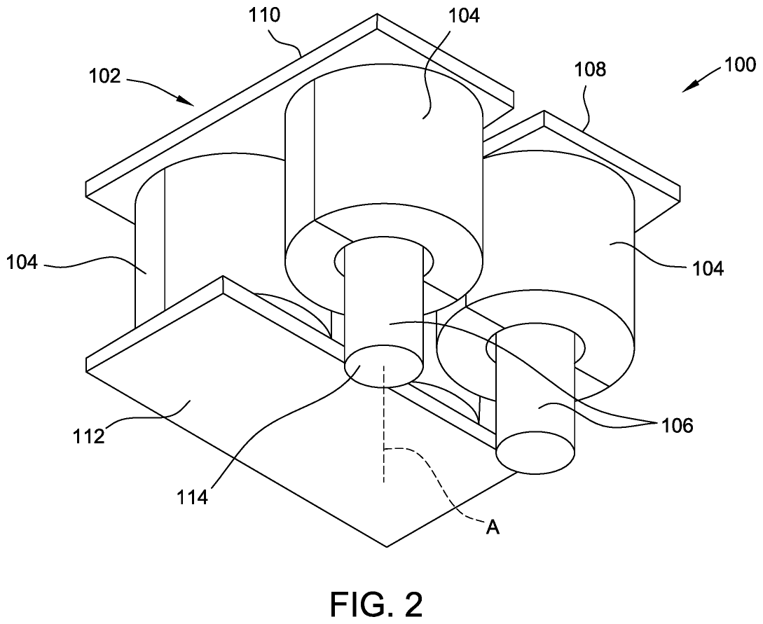

FIG. 4 is a conceptual drawing showing the current and flux flow of the integrated magnetic assembly 100 shown in FIG. 2. The dots 120 represent current flowing through the winding legs 106, coming out of the page along a direction generally defined by axis A, creating a counterclockwise flow of flux in the corresponding toroid 104. The x's 122 represent current flowing through the winding leg 106, going into the page along a direction generally defined by axis A, which creates a clockwise flow of flux in the associated toroid 104. The above-described structure of the winding causes current flow in the directions indicated in FIG. 4. In the present embodiment, the toroids 104 form separate inductors.

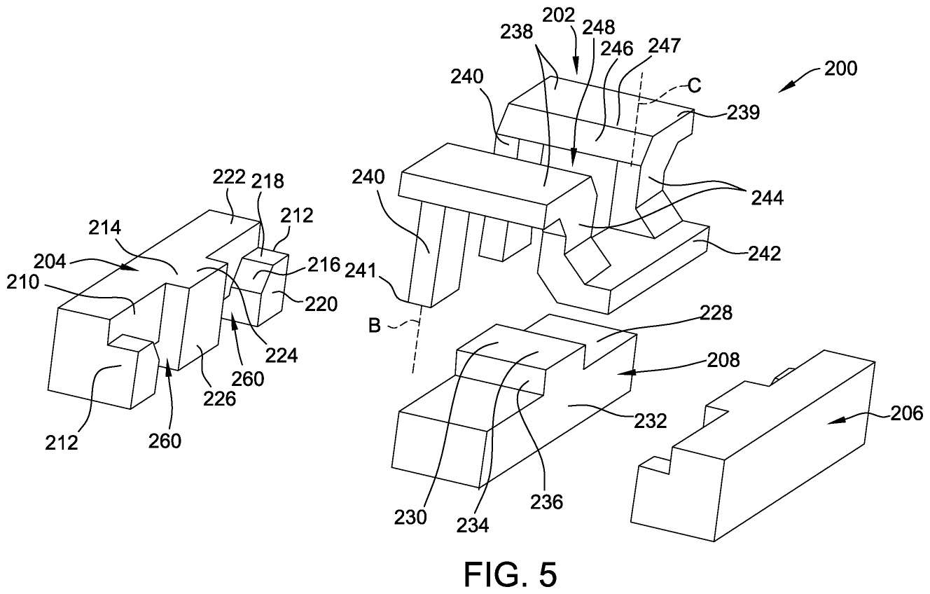

FIG. 5 depicts an embodiment of an integrated magnetic assembly 200 of the present disclosure including a winding 202, a first core component 204, a second core component 206, and a center core component 208.

First core component 204 and second core component 206 are substantially similar and/or mirror images of one another. First and second core components 204, 206 each include an inner face 210, a pair of outer legs 212, and a center leg 214. The outer legs 212 extend outwardly from face 210. Outer legs 212 include a chamfered edge 216, a top face 218, and a mating face 220. The top face 218 is offset from, and below the plane defined by a top face 222 of the core component 204, 206. In the present embodiment, each outer leg 212 has a substantially rectangular shape, extending from the inner face 210 of the core component 204, 206. In other embodiments, outer legs 212 may be any suitable shape. Center leg 214 also extends from the inner face 210 of the first and second core components 204, 206 and includes a top face 224 and a mating face 226. Center leg 214 is located between the outer legs 212. In the present embodiment, the top face 224 of the center leg 214 is flush and coplanar with the top face 222 of the core component 204, 206.

Center core component 208 includes a top face 228, a projection 230, a first inner side (not shown), and a second inner side 232. The projection 230 extends upwardly from top face 228 and further includes an upper surface 234. The surface or plane defined by upper surface 234 is generally parallel to the surface defined by top face 228, and extends a distance above the top face 228, forming a projection sidewall 236.

Winding 202 includes a pair of winding plates 238, a pair of winding legs 240 extending perpendicular to, and downwardly from the winding plates 238, a connection tab 242, and connection legs 244 that are spaced from the winding legs. The connection legs 244 also extend perpendicular to and downwardly from the winding plates 238. An axis B is defined along a longitudinal axis of each of the winding legs 240, and an axis C is defined along a longitudinal axis of each of the connection legs 244. The connection tab 242 is made integral with the connection legs 244. The connection tab is substantially rectangular. The winding plates 238 are essentially rectangular and include a slanted face 246 that extends from an upper edge 247 of winding plate 238. Each of the winding plates 238 also includes an extension 239 which extends outward from the winding plate opposite the portion of the winding plate that includes the slanted face 246. The extension 239 extends beyond connection legs 244. The shape and size of the extension 239 causes the extension to act as a heat sink and also as a low resistive winding path.

The pair of winding plates 238 are spaced apart and essentially oriented in parallel. The distance separating the winding plates defines a slot 248 therebetween. The width of the slot 248 is sized to be able to receive projection 230 of the center core component 208 in the slot 248 when the integrated magnetic assembly 200 is assembled. The width of the slot 248 is also sized to be able to receive center leg 214 of the first core component 204 between the winding legs 240 and the center leg 214 of the second core component 206 between the connection legs 244. The connection legs 244 are any shape which allows the winding plates 238 to connect to the connection tab 242. The winding plates 238, winding legs 240, connection tab 242, and connection legs 244 form an electrically continuous winding.

When assembled, the integrated magnetic assembly includes a plurality of channels 260 which are defined by the inner face 210 of the first or second core components 204, 206, the first or second inner sides 232 of the center core component 208, the outer legs 212 of the first or second core components 204, 206, and the center leg 214 of the center core component 208. Each of the winding legs 240 and each of the connection legs 244 are located within one the plurality of channels 260. In the present embodiment, each of the winding legs 240 is located within one channel of a first pair of channels 260 formed between the first core component 204 and the center core component 208, and each of the connection legs 244 is located within one channel of a second pair of channels 260 formed between the second core component 206 and the center core component 208.

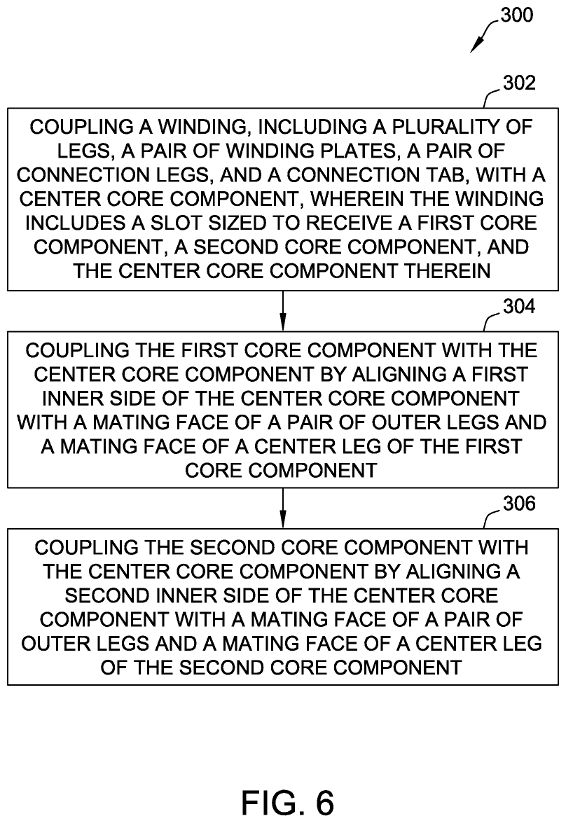

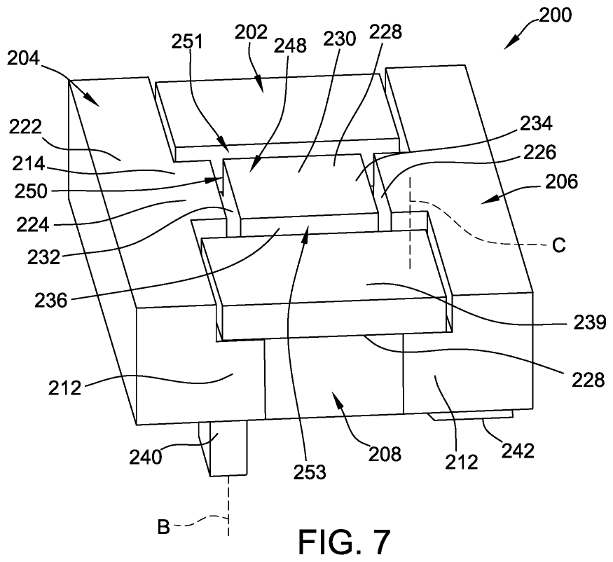

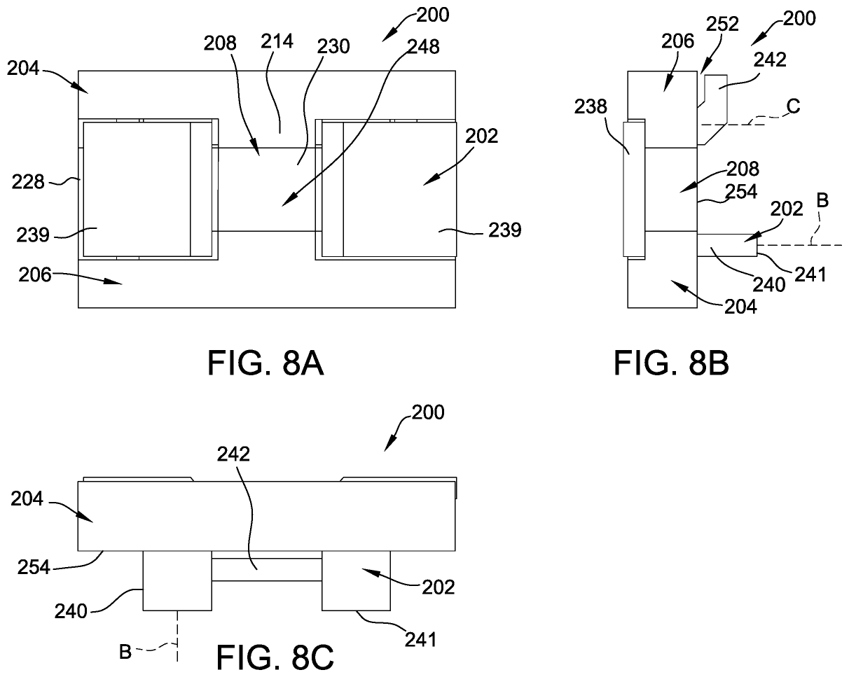

FIG. 6 depicts a method 300 of forming the integrated magnetic assembly 200 shown in FIG. 5. The method includes coupling 302 a winding 202, including a plurality of legs 240, 244, a pair of winding plates 238, a pair of connection legs 244, and a connection tab 242, with a center core component 208, wherein the winding 202 includes a slot 248 sized to receive the center core component 208 therein. Referring to FIGS. 7 and 8A, the slot 248 is sized to receive the projection 230 of the center core component 208 therebetween. The extensions 239 of each of the winding plates 238 extend over the outer legs 212 and the chamfered edges 216 of the first and second core components 204, 206, along and parallel to the top face 228 of the center core component 208, as depicted in FIGS. 7 and 8A. The extensions 239 act as a heat sink, providing adequate surface area capable of conducting heat produced in the core components 204, 206, 208 into the surrounding air, providing adequate cooling to the integrated magnetic assembly 200 and allowing for more efficient operation. The method 300 further includes coupling 304 a first core component 204 with the center core component 208 by aligning a first inner side (not shown) of the center core component 208 with a mating face 220 of a pair of outer legs 212 and a mating face 226 of a center leg 214 of the first core component 204, and coupling 306 a second core component 206 with the center core component 208 by aligning a second inner side 232 of the center core component 208 with a mating face 220 of a pair of outer legs 212 and a mating face 226 of a center leg 214 of the second core component 206. Referring to FIG. 7, the assembled integrated magnetic assembly 200 is shown, wherein the winding 202 is shown coupled with the first core component 204, the second core component 206, and the center core component 208. The winding legs 240 and the connection legs 244 extend through the channels 260 shown in FIG. 5 and described above. As shown in FIGS. 8B and 8C, the winding legs 240 and the connection legs 244 extend down beyond a bottom edge 254 of the first, second, and center core components 204, 206, 208.

“Coupling”, as described herein, refers to bringing two surfaces into close proximity, however the surfaces may be slightly gapped. The size of the gap affects the properties of the magnetic flux induced, and the gap may be varied in size based on the requirements of the magnetic core. The gaps created in coupling the various components described herein may be filled with an interfacial epoxy with glass bead or Nomex with a bridge bond.

FIGS. 7 and 8A-C show the assembled integrated magnetic assembly 200, wherein the winding 202 is shown coupled with the first core component 204, the second core component 206, and the center core component 208. The winding legs 240 and the connection legs 244 extend through respective channels 260 shown in FIG. 5 and described above. Referring to FIG. 7, center leg 214 extends from the inner face 210 at a distance less than the distance that the outer legs 212 extend from the inner face 210. Gap 250 is present because of this difference in lengths. Gaps 251, 253 are also defined between the projection sidewalls 236 of the center component 208 and the slanted face 246 of the winding 202. Further, gaps are generally formed between the surfaces of the coupled first core component 204, center core component 208, second core component 206, and the winding 202. The winding plates 238 fit within the recess created by the assembled core components 204, 206, 208, with the bottom surface of the winding plates 238 resting upon the top face 218 of each of the outer legs 212 of first and second core components 204, 206.

Referring to FIG. 8B, the connection tab 242 extends below the bottom edge of the second core component 206, defining a gap 252. As shown in FIGS. 8C and 8B, the pair of winding legs 240 extend downward from the winding plates 238 below a bottom edge of the first core component 204. In the present embodiment, the distance from the winding plates 238 to the connection tab 242 is less than the distance from the winding plates to first end 241 of the pair of winding legs 240.

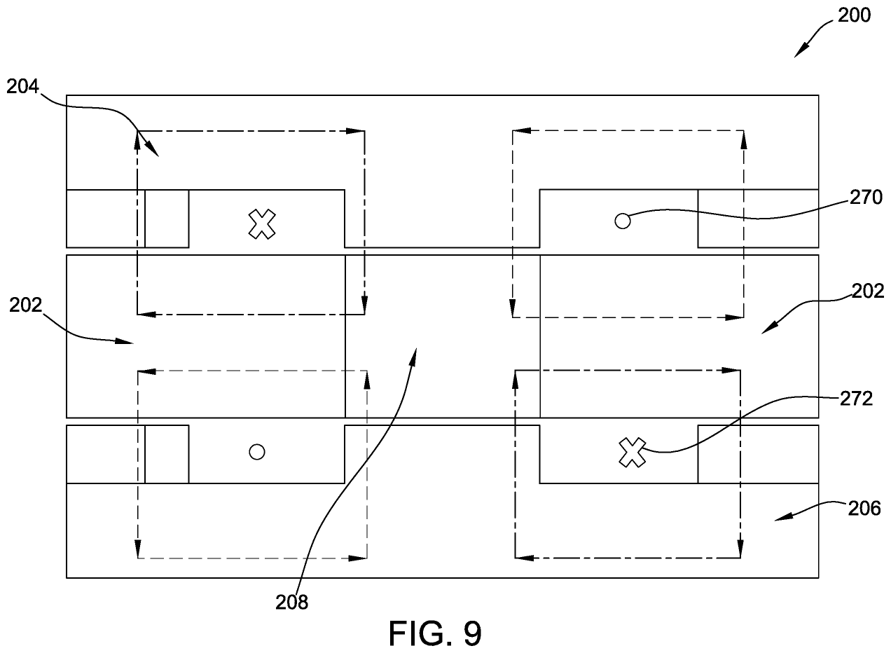

FIG. 9 is a conceptual drawing showing the current and flux flow of the integrated magnetic assembly 200 shown in FIG. 7. The dots 270 represent current flowing through the winding 202, coming out of the page along a direction generally defined by axes B and C, creating a counterclockwise flow of flux in the core assembly. The x's 272 represent current flowing through the winding 202 going into the page along a direction generally defined by axes B and C, which creates a clockwise flow of flux in the core assembly. The above-described structure of the winding 202 causes current flow in the directions shown in FIG. 9. In the present embodiment, the space or gaps between the cores provides a desired value of inductance and current handling capability. The gaps are created by the specific geometry of the winding 202 and the core components 204, 206, 208. Therefore, the gaps may be formed at the boundaries between the winding 202 and the core components 204, 206, 208, depending on the exact dimensions of the components.

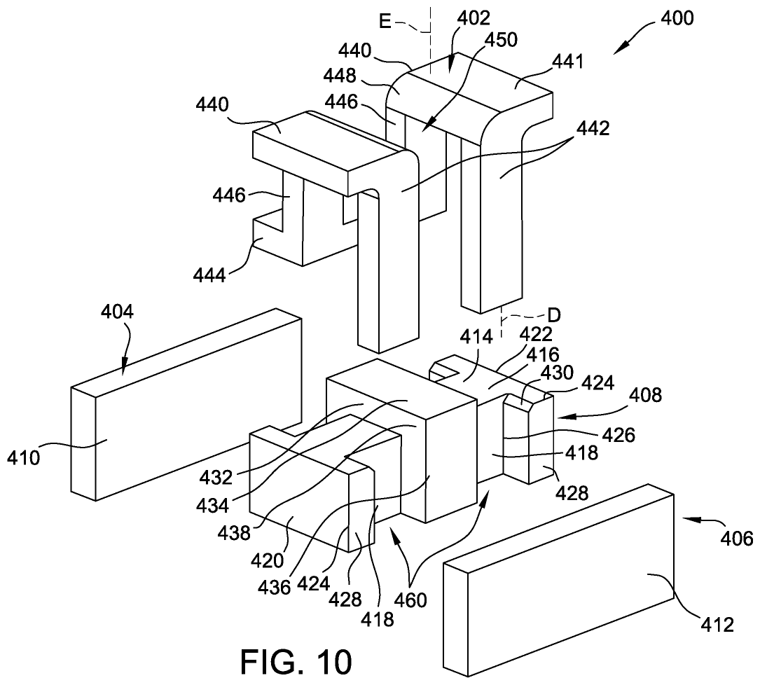

FIG. 10 depicts an exploded view of another embodiment of an integrated magnetic assembly 400 of the present disclosure including a winding 402, a first core component 404, a second core component 406, and a center core component 408.

First core component 404 and second core component 406 are substantially similar. First and second core components 404, 406 include an inner face 410 and an outer face 412 and are substantially rectangular in shape. However, first and second core components 404, 406 may be any suitable shape in other embodiments.

Center component 408 includes a main body 414 which is substantially rectangular. The main body 414 includes a top face 416, a first sidewall 418, a second sidewall (not shown) and a bottom face (not shown). In the present embodiment, the length of the first and second core components 404, 406 is approximately the same as the length of the main body 414 of the center component 408. The center component 408 further includes a first flange 420 and a second flange 422. The first and second flanges 420, 422 define legs 424 which extend outward from the main body 414. Each leg 424 defines an inner side wall 426 and a face 428. Each leg 424 also includes a chamfered corner 430.

Center component 408 also includes a center flange 432. The center flange 432 includes a top surface 434, a first side surface (not shown), a second side surface 436, a first inner sidewall 438 and a second inner sidewall (not shown). The top surface 434 of the center flange 432 is essentially parallel to the top face 416 of the main body 414. The first side surface (not shown) and the second side surface 436 are essentially parallel to the first sidewall 418 and the second sidewall (not shown) of the main body 414.

Winding 402 is similar to winding 202, except as denoted below. Winding 402 includes a pair of winding plates 440, a pair of winding legs 442 extending perpendicular to, and downwardly from the winding plates 440, a connection tab 444, and connection legs 446 that are spaced from the winding legs 442. The connection legs 446 also extend perpendicular to and downwardly from the winding plates 440. An axis D is defined along a longitudinal axis of each of the winding legs 442, and an axis E is defined along a longitudinal axis of each of the connection legs 446. The connection tab 444 is made integral with the connection legs 446. The connection tab 444 is substantially rectangular. The winding plates 440 are substantially rectangular and include a curved inner edge 448. Each of the winding plates 440 also includes an extension 441 which extends outward from the curved inner edge 448. The shape and size of the extension 441 acts as a heat sink and a low resistive winding path.

The pair of winding plates 440 are spaced apart and substantially oriented in parallel. The distance separating the winding plates 440 defines a slot 450 therebetween. The width of the slot 450 is sized to be able to receive the center flange 432 of the center component 408 in the slot 450 when the integrated magnetic assembly 400 is assembled. The winding plates 440, winding legs 442, connection tab 444, and connection legs 446 form an electrically continuous winding.

When assembled, the integrated magnetic assembly includes a plurality of channels 460 which are defined by the inner face 410 of the first or second core components 404, 406, the first or second sidewalls 418 of the center core component 408, the center flange 432 of the center core component 408, and the first or second flanges 420, 422 of the center core component 408. Each of the winding legs 442 and each of the connection legs 446 is located within one of the plurality of channels 460. In the present embodiment, each of the winding legs 442 is located within one of a first pair of channels 460 formed between the first core component 404 and the center core component 408, and each of the connection legs 446 is located within one of a second pair of channels 460 formed between the second core component 406 and the center core component 408.

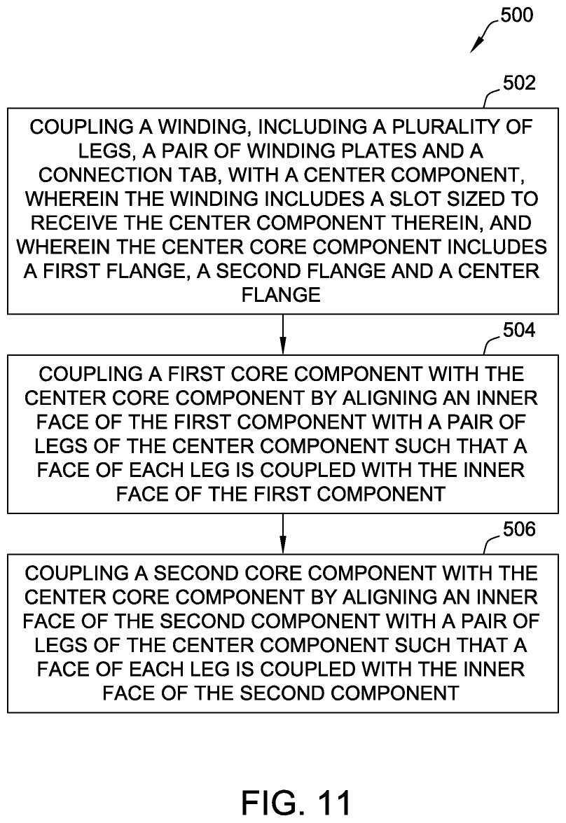

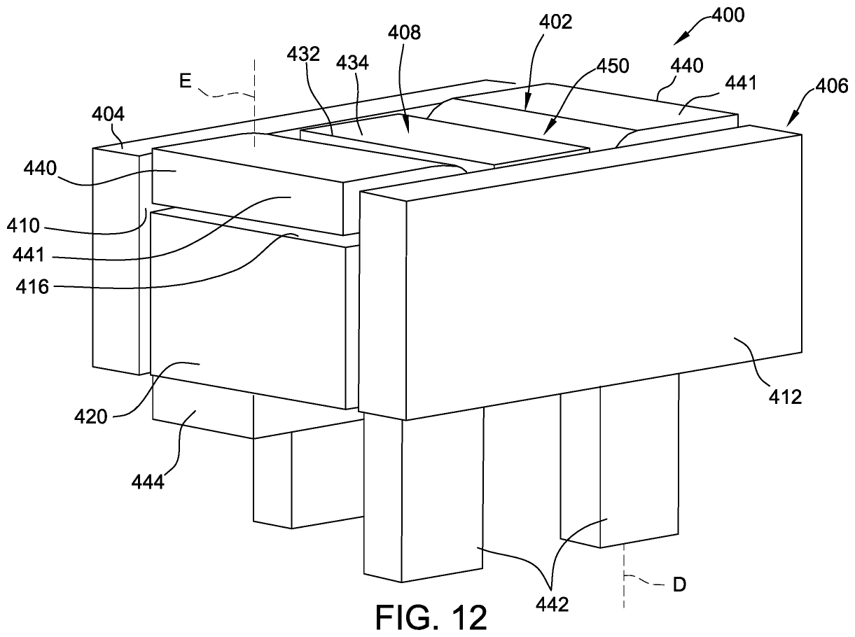

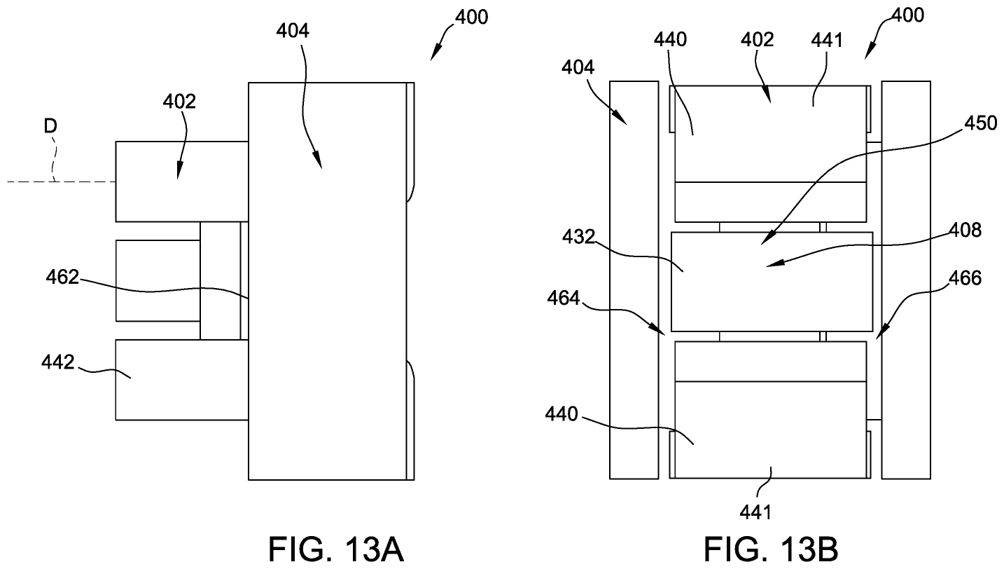

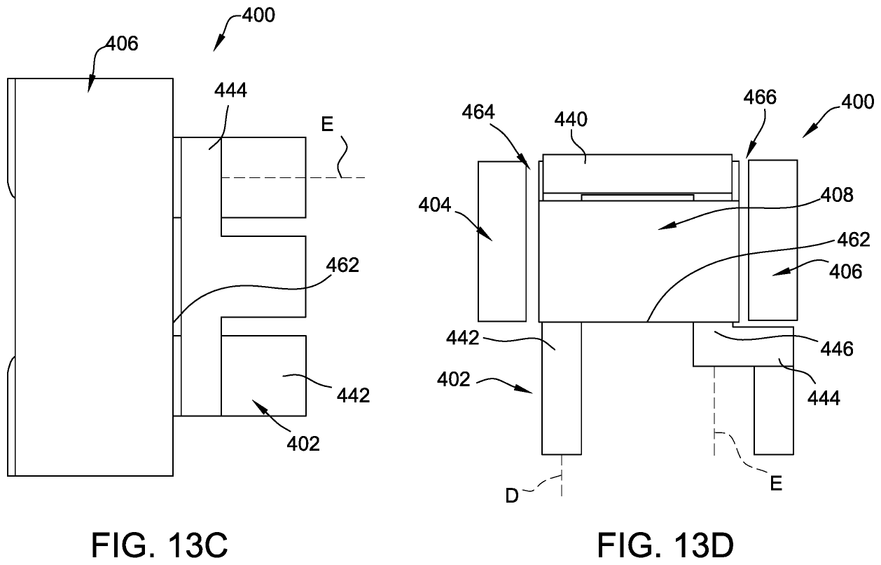

FIG. 11 depicts a method 500 of assembling the integrated magnetic assembly 400 depicted in FIG. 10. The method 500 is substantially similar to method 300, except as denoted below. The method 500 includes coupling 502 a winding 402, including a plurality of legs 442, 446, a pair of winding plates 440 and a connection tab 444, with a center component 408, wherein the winding 402 includes a slot 450 sized to receive the center component 408 therein, and wherein the center core component 408 includes a first flange 420, second flange 422 and center flange 432. Referring to FIGS. 12 and 13B, the slot 450 is sized to receive the center flange 432 of the center core component 408 therebetween. The extensions 441 of each of the winding plates 440 extend, in a direction along and parallel to the top face 416, over the first flange 420 and the second flange 422 of the center core component 408, as depicted in FIGS. 12 and 13B. The extensions 441 act as a heat sink, providing adequate surface area capable of conducting heat produced in the core components 404, 406, 408 into the surrounding air, providing adequate cooling to the integrated magnetic assembly 400 and allowing for more efficient operation. The method 500 further includes coupling 504 a first core component 404 with the center core component 408 by aligning an inner face 410 of the first component 404 with a pair of legs 424 of the center component 408 such that a face 428 of each leg 424 is coupled with the inner face 410 of the first component 404, and coupling 506 a second core component 406 with the center core component 408 by aligning an inner face 410 of the second component 406 with a pair of legs 424 of the center component 408 such that a face 428 of each leg 424 is coupled with the inner face 410 of the second component 406. Referring to FIG. 12, the assembled integrated magnetic assembly 400 is shown, wherein the winding 402 is shown coupled with the first core component 404, the second core component 406, and the center core component 408. The winding legs 442 and the connection legs 446 extend through the respective channels 460 shown in FIG. 10 and described above. As shown in FIGS. 13A, 13C and 13D, the winding legs 442 and the connection legs 446 extend down beyond a bottom edge 462 of the first, second, and center core components 404, 406, 408.

FIGS. 12 and 13A-D show the assembled integrated magnetic assembly 400, wherein the winding 402 is shown coupled with the first core component 404, the second core component 406, and the center core component 408. The winding legs 442 and the connection legs 446 extend through the channels 460 shown in FIG. 5 and described above.

Referring to FIGS. 13B and 13D, gap 464 is defined between the first core component 404, the center core component 408, and the winding 402. Similarly, gap 466 is defined between the second core component 406, the center core component 408, and the winding 402. Gaps are generally formed between the surfaces of the coupled first core component 404, the center core component 408, the second core component 406, and the winding 402. As shown in FIG. 13B, the winding plates 440 fit within the recess created by the assembled core components 404, 406, 408, with the bottom surface of the winding plates 440 resting upon the top surface 434 of each of the center core component 408.

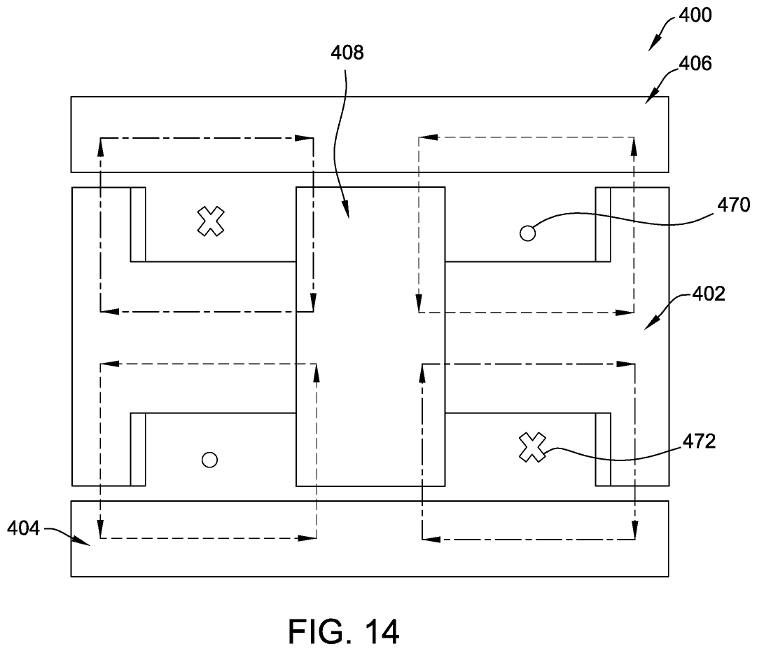

FIG. 14 is a conceptual drawing showing the current and flux flow of the integrated magnetic assembly 400 shown in FIG. 10. The dots 470 represent current flowing through the winding 402, coming out of the page along a direction generally defined by axes D and E, creating a counterclockwise flow of flux in the core assembly. The x's 472 represent current flowing through the winding 402, going into the page along a direction generally defined by axes D and E, which creates a clockwise flow of flux in the core assembly. The above-described structure of the winding causes current flow in the directions shown in FIG. 14. In the present embodiment, the space or gaps between the cores provides a desired value of inductance and current handling capability. The gaps are created by the specific geometry of the winding 402 and the core components 404, 406, 408. Therefore, the gaps may be formed in any of the boundaries between the winding 402 and the core components 404, 406, 408, depending on the exact dimensions of the components.

An exemplary technical effect of the embodiments described herein includes at least one of: (a) increased power density, (b) decrease in size due to multiple inductors in series.

Although specific features of various embodiments of the disclosure may be shown in some drawings and not in others, this is for convenience only. In accordance with the principles of the disclosure, any feature of a drawing may be referenced and/or claimed in combination with any feature of any other drawing.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. An integrated magnetic assembly comprising:
a magnetic core assembly comprising:
a first core component including a first plurality of legs extending from a first inner face;
a second core component including a second plurality of legs extending from a second inner face; and
a center core component located between the first core component and the second core component and coupled to the first and second core components, the center core component including a top surface, a first inner side and a second inner side; and
a winding comprising a pair of winding plates, a pair of winding legs extending from a first end of the pair of winding plates, a pair of connection legs extending from a second end of the pair of winding plates, and a connection tab joining the connection legs,
wherein, where the first plurality of legs of the first core component and the first inner side of the center core component define at least two first channels, and the second plurality of legs of the second core component and the second inner side of the center core component define at least two second channels,
wherein each of the winding legs and each of the connection legs are located in one of the two first channels or one of the two second channels.

2. The integrated magnetic assembly of claim 1, wherein each of the winding plates further comprise an extension, each extension extending in a direction parallel to the top surface of the center core component, over the first or second plurality of legs, and wherein each extension acts as a heat sink.

3. The integrated magnetic assembly of claim 1, wherein a first center leg of the first plurality of legs of the first core component is longer in a direction parallel to the first inner face than a first pair of outer legs of the first plurality of legs, and wherein a second center leg of the second plurality of legs of the second core component is longer in a direction parallel to the second inner face than a second pair of outer legs of the second plurality of legs.

4. The integrated magnetic assembly of claim 1, wherein a plurality of gaps are formed between the first core component, the second core component, the center core component, and the winding.

5. The integrated magnetic assembly of claim 4, wherein the plurality of gaps are filled with at least one of an interfacial epoxy with glass bead and Nomex with a bridge bond.

6. The integrated magnetic assembly of claim 1, wherein the center core component includes a projection extending from the top surface, wherein the pair of winding plates are spaced apart and define a slot sized to accommodate the projection of the center core component, at least one of the first plurality of legs of the first core component, and at least one of the second plurality of legs of the second core component.

7. The integrated magnetic assembly of claim 6, wherein a height of the projection above the top surface of the center core component is approximately a thickness of the pair of winding plates.

8. The integrated magnetic assembly of claim 1, wherein the winding legs are located in the at least two first channels and the connection legs are located in the at least two second channels.

9. The integrated magnetic assembly of claim 1, wherein the winding legs are located in the at least two second channels and the connection legs are located in the at least two first channels.

10. A method for assembling an integrated magnetic assembly, the method comprising:
coupling a winding with a center core component of a magnetic core assembly, wherein the winding includes a pair of winding plates, a pair of winding legs extending from a first end of the pair of winding plates, a pair of connection legs extending from a second end of the pair of winding plates, and a connection tab joining the connection legs, wherein the center core component includes a top surface, a first inner side, and a second inner side, wherein the each of the winding legs and each of the connection legs are coupled with the center core component;
coupling a first core component to the center core component, wherein coupling the first core component and the center core component defines at least two first channels; and
coupling a second core component to the center core component, wherein coupling the second core component and the center core component defines at least two second channels,
wherein each of the winding legs and each of the connection legs are located in one of the two first channels or one of the two second channels.

11. The method of claim 10, wherein the method further includes:
coupling a top surface of the connection tab to a bottom surface of the magnetic core assembly.

12. The method of claim 10, wherein a first center leg of the first core component is longer in a direction parallel to the first inner side than a first pair of outer legs of the first core component, and wherein a second center leg of the second core component is longer in a direction parallel to the second inner side than a second pair of outer legs of the second core component.

13. The method of claim 10, wherein a plurality of gaps is formed between the first core component, the second core component, the center core component, and the winding, wherein the method further comprises:
filling the plurality of gaps with at least one of an interfacial epoxy with glass bead and Nomex with a bridge bond.

14. The method of claim 10, wherein each of the winding plates further comprise an extension, each extension extending in a direction parallel to the top surface of the center core component, and wherein each extension acts as a heat sink.

15. An integrated magnetic assembly comprising:
a magnetic core assembly comprising:
a first core component;
a second core component; and
a center core component, located between the first core component and the second core component and coupled to the first core component and the second core component, the center core component including a top face, a first side, a second side; and
a winding comprising a pair of winding plates, a pair of winding legs extending from a first end of the pair of winding plates, a pair of connection legs extending from a second end of the pair of winding plates, and a connection tab joining the connection legs,
wherein at least two first channels are defined between the first core component and the center core component, and at least two second channels are defined between the second core component and the center core component,
wherein each of the winding legs and each of the connection legs are located in one of the two first channels or one of the two second channels.

16. The integrated magnetic assembly of claim 15, wherein each of the winding plates further comprise an extension, each extension extending in a direction parallel to the top face of the center core component, over the center core component, and wherein each extension acts as a heat sink.

17. The integrated magnetic assembly of claim 15, wherein a plurality of gaps is formed between the first core component, the second core component, the center core component, and the winding.

18. The integrated magnetic assembly of claim 17, wherein the plurality of gaps is filled with at least one of an interfacial epoxy with glass bead and Nomex with a bridge bond.

19. The integrated magnetic assembly of claim 15, wherein the center core component includes a projection extending from the top face, wherein the pair of winding plates form a slot sized to accommodate the projection of the center core component.

20. The integrated magnetic assembly of claim 19, wherein a height of the projection above the top face of the center core component is approximately a thickness of the pair of winding plates.
